(19) United States
(12) Patent Application Publication
(10) Pub. No.: US 2014/0032084 A1
(43) Pub. Date: Jan. 30, 2014

(54) Temperature-Controlled Combustion System and Method

(71) Applicants: Christopher R. Gehrke, Chillicothe, IL (US); George Donaldson, Chillicothe, IL (US)

(72) Inventors: Christopher R. Gehrke, Chillicothe, IL (US); George Donaldson, Chillicothe, IL (US)

(73) Assignee: CATERPILLAR INC., Peoria, IL (US)

(21) Appl. No.: 13/559,801

(22) Filed: Jul. 27, 2012

(51) Int. Cl. F02D 41/34; F02B 17/00

(52) U.S. Cl. 701/105; 123/295

(57) ABSTRACT

An internal combustion engine system is configured to operate using a first fuel of a first reactivity and a second fuel of a second reactivity. The engine system measures an operating parameter of the internal combustion system. The engine system further introduces to a combustion chamber of the engine system and combusts therein the first fuel and the second fuel during high temperature/speed (HTS) conditions. The engine system also introduces to the combustion chamber and combusts primarily only one of the first fuel or second fuel during a low temperature/speed (LTS) condition.

### TECHNICAL FIELD

This patent disclosure relates generally to internal combustion engines and, more particularly, to internal combustion engines that operate using more than one fuel.

### BACKGROUND

Internal combustion engines operating with more than one fuel are known. Certain engines use two or more fuels having different reactivities. One example of such an engine can be seen in U.S. Patent Application Pub. No. 2011/0192367, which was published on Aug. 11, 2011 to Reitz et al. (hereafter, “Reitz”) herein incorporated by reference in its entirety. Reitz describes a compression ignition engine that uses two or more fuel charges having two or more reactivities in a combustion process that is sometimes referred to as reactivity controlled compression ignition (“RCCI”). According to Reitz, two fuels can be introduced into the combustion chamber at different times during an intake-compression stroke to produce stratified regions having different reactivities that will spontaneously ignite under compression. The relative reactivities of the fuels and timing of their introduction determines in part ignition timing, combustion rate, fuel efficiency, engine power output and emissions among other aspects.

Among the factors that can affect ignition timing in Reitz is in-cylinder temperature. When the internal combustion engine is running within its rated speed range, temperature of the air/fuel mixture within the engine cylinders prior to combustion can, in part, control the spontaneous ignition and thorough combustion of the stratified regions of the two fuels within the combustion chamber. However, at low operating temperatures such as during engine start-up or while the engine is idling, it may be difficult to control the ignition timing and therefore the rate or duration of combustion. Hence, during these low temperature conditions, some of the benefits and efficiencies of the dual reactivity system of Reitz may not be realized.

### SUMMARY

The disclosure describes, in one aspect, a method of operating an internal combustion engine configured to utilize fuels of two different reactivities. The method includes measuring an operating parameter of the internal combustion system. The method can introduce to a combustion chamber and combust a first fuel having a first reactivity and a second fuel having a second reactivity during a high temperature/speed (HTS) condition of the internal combustion system. The introduction of the first fuel and the second fuel occurs at different times during the internal combustion cycle. The method can also introduce to the combustion chamber and combust primarily only one of the first fuel or second fuel during a low temperature/speed (LTS) condition of the internal combustion system.

The disclosure further describes, in another aspect, an internal combustion engine system having a first fuel reservoir storing a first fuel of a first reactivity and a second fuel reservoir storing a second fuel of a second reactivity. The internal combustion engine includes a combustion chamber having a piston movable in a cylinder. A first injector associated with the combustion chamber can introduce the first fuel to the combustion chamber and a second injector associated with the internal combustion chamber can introduce the second fuel. The internal combustion engine also includes a sensor measuring an operating parameter associated with the internal combustion engine. A controller communicates with the sensor, to receive the operating parameter. During a low temperature/speed (LTS) condition of the internal combustion engine, the controller controls the first and second injectors to introduce primarily only one of the first or second fuels to the combustion chamber during the internal combustion process. However, during a high temperature/speed (HTS) condition of the internal combustion system, the controller controls the first and second injectors to introduced both the first fuel and the second fuel to the combustion chamber at different times during the internal combustion cycle.

The disclosure also describes, in another aspect, a method to be performed by an electronic controller of operating an internal combustion engine system. The method includes receiving by the electronic controller a signal indicative of an operating parameter of the internal combustion engine system. The method determines if the operating parameter indicates whether the internal combustion engine is in a low temperature/speed (LTS) condition or in a high temperature/speed (HTS) condition. If in the LTS condition, the method issues a first instruction to operate the internal combustion engine system using primarily a first fuel having a first reactivity. When in the HTS condition, the method issues a second instruction to operate the internal combustion engine system using the first fuel having the first reactivity and a second fuel having a second reactivity. The method repeats itself to switch between issuing the first instruction and issuing the second instruction depending upon change in the operating parameter.

### BRIEF DESCRIPTION OF THE DRAWINGS

FIG. 1 is a block diagram of an engine system having an internal combustion engine adapted for RCCI operation by burning fuels having different reactivities, which is further configured for operation at low engine temperatures and speeds.

FIG. 2 is a cross-sectional view of an engine cylinder with a movable piston therein that can be disposed in the internal combustion engine and which shows the valves, camshafts, and fuel injectors operating in conjunction with each other.

FIGS. 3-5 are cross-sectional views of the engine cylinder and the piston movably disposed therein at various points during a compression cycle during which stratified regions of different reactivities are formed within the cylinder.

FIG. 6 is a valve timing diagram for running a Miller thermodynamic cycle with the disclosed engine system.

FIG. 7 is a schematic flow chart representing a possible routine or steps for running the engine system adapted to operate the RCCI combustion process during a high temperature/speed condition and during a low temperature/speed condition.

### DETAILED DESCRIPTION

This disclosure relates to internal combustion engines and, more particularly, to internal combustion engines that operate using more than one fuel, for example, in an RCCI combustion process, and machines that include such engine systems. Internal combustion engines burn a hydrocarbon-based fuel or another combustible fuel source to convert the potential or chemical energy therein to mechanical energy in the form of physical motion that can be harnessed for other work. In one embodiment, the disclosed engine operates using a high reactivity fuel such as diesel in conjunction with a low reactivity fuel such as gasoline, although alternative embodiments in which a single fuel that is processed so as to have two different reactivities or two other kinds of fuels are contemplated. In the various embodiments contemplated, fuels having different reactivities are introduced to an engine cylinder by various methods including direct injection of one or more fuels into the cylinder and/or indirect injection methods. Indirect fuel injection methods can be tailored to the particular type of fuel being used. For example, a gaseous fuel such as propane or natural gas can be dispersed into the intake manifold of the engine for mixing with engine intake air, while a liquid fuel such as gasoline can be injected at or close to a cylinder intake port for mixing with air entering the cylinder.

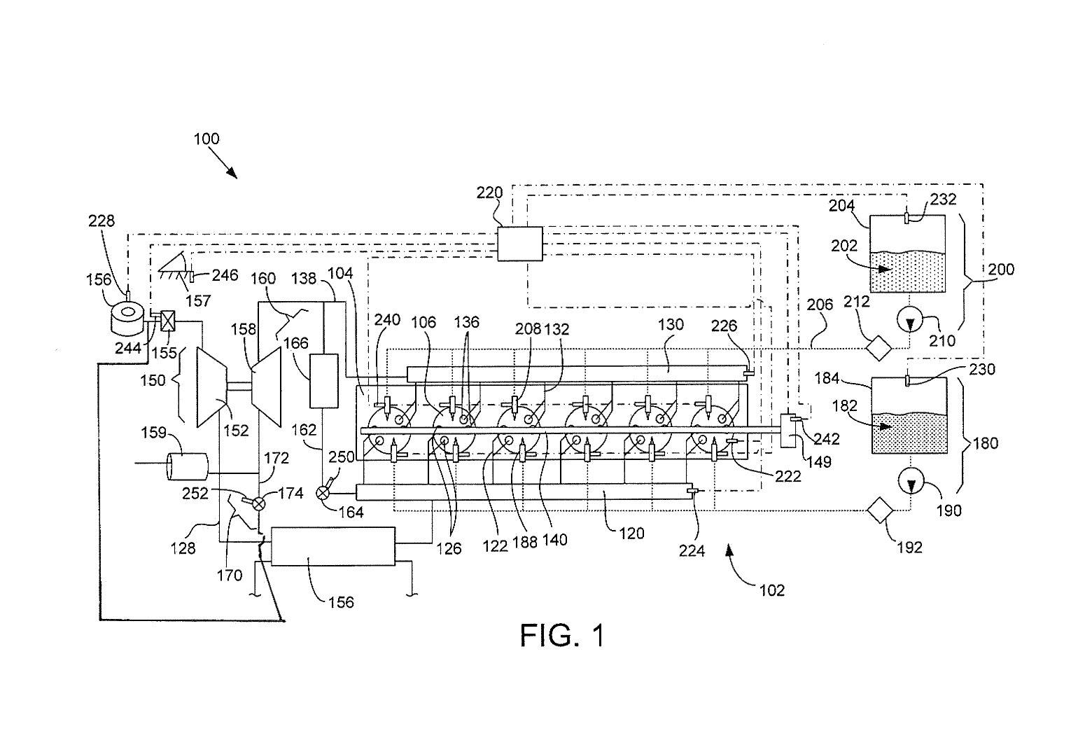

Referring to FIG. 1, wherein like reference numbers refer to like elements, a block diagram for an engine system 100 is depicted. The engine system 100 includes an internal combustion engine 102 and, in particular, a compression ignition engine in which an air/fuel mixture is compressed raising the pressure and temperature to a point at which auto-ignition or spontaneous ignition occurs. In alternative embodiments, depending on the type of fuels used, the engine may be a spark ignition engine wherein a spark plug initiates ignition. The illustrated internal combustion engine 102 includes an engine block 104 in which a plurality of combustion chambers 106 are disposed. Although six combustion chambers 106 are shown, in other embodiments fewer or more combustion chambers may be arranged in an inline configuration or another configuration such as a V-configuration.

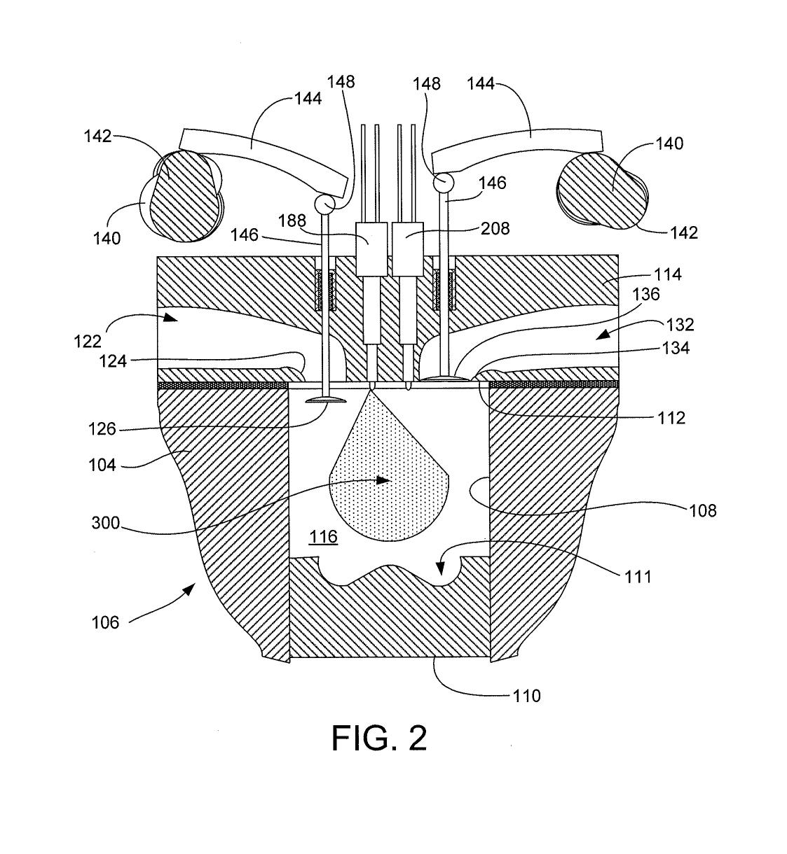

Referring to FIG. 2, each combustion chamber 106 includes a bore or cylinder 108 that may be bored or formed into the engine block 104 and that can slidably accommodate a movable piston 110 therein. Disposed into the upper face or surface of the piston 110 can be a contoured bowl 111 that can be shaped to channel or direct gas flow within the combustion chamber 106. One end of the cylinder 108 is closed by a flame deck surface 112 disposed along the lowermost surface of a cylinder head 114 that caps the engine block 104. The combustion chamber 106 is therefore generally enclosed by the cylinder 108, the movable piston 110, and the flame deck surface 112. The reciprocal piston 110 moves in the cylinder 108 between a top dead center (TDC) position wherein the piston is closest to the flame deck surface 112 and a bottom dead center (BDC) position where the piston is furthest from the flame deck surface. The combustion chamber 106 thereby defines a variable volume 116 that expands and contracts as the piston 110 reciprocates within the cylinder 108 between the TDC position, where the variable volume is at its smallest, and the BDC position, where the variable volume is at its largest.

The reciprocal motion of the piston 110 within the cylinder and the expansion and contraction of the variable volume 116 accomplish an internal combustion cycle. An internal combustion cycle can include an intake stroke in which air and/or fuel may be introduced to the combustion chamber 106, independently or separately, as the piston 110 moves from the TDC position to a BDC position. The internal combustion cycle can also include a compression stroke in which the piston 110 moves back to the TDC position compressing the air/fuel mixture to the point of ignition. The compression ratio of a typical diesel-burning internal combustion engine may be on the order of 15:1 although other compression ratios are common. During a power stroke, the combusting mixture expands and forces the piston 110 down again to the BDC position. The piston 110 can be connected or linked to a crankshaft so that its linear motion is converted to rotational motion that can be harnessed to power an application or machine. To expel the combusted exhaust gasses from the cylinder 108, inertia from the crankshaft and/or power strokes occurring in other combustion chambers 106 can drive the piston 110 back to the TDC position during an exhaust stroke.

Referring to FIGS. 1 and 2, to direct the intake air used in the combustion process, an intake manifold 120 can be disposed in or attached to the engine block 104 and extend along and/or over each of the combustion chambers 106. Fluid communication between the intake manifold 120 and the combustion chambers 106 can be established by a plurality of intake runners 122 extending from the intake manifold and, in the illustrated embodiment, that may be disposed completely or in part through the cylinder head 114. At least one intake runner 122 is associated with each combustion chamber 106 and terminates at an intake port 124 that may be disposed through the flame deck surface 112 or another portion of the cylinder and that can be selectively opened and closed by an intake valve 126. If the piston 110 is moving through the intake stroke from the TDC position downwards to the BDC position while the intake valve 136 is opened, the variable volume 116 will expand to accept therein intake air through the intake port 124 from the intake runner 122. In the illustrated embodiment, the intake port 124 and the intake valve 126 have a generally circular cross section, but in other embodiments could have other suitable shapes and could be formed at locations other than the flame deck surface 112. To receive intake air from the environment and communicate with the other components of the intake system, the intake manifold 120 can be associated with an intake line 128 disposed through the engine system 100.

To receive the exhaust gasses expelled from the combustion chamber 106 by the exhaust stroke, an exhaust manifold 130 can be disposed in or attached to the engine block 104 in a manner that functionally mirrors the intake manifold 120. The exhaust manifold 130 can communicate with the combustion chambers 106 by a plurality of exhaust runners 132 that extend from the exhaust manifold and terminate at an exhaust port 134 proximate to the cylinder 108. At least one exhaust runner 132 and one exhaust valve 136 can be associated with each cylinder 108. Similar to the intake system, the exhaust runner 132 and the exhaust port 134 can be disposed in the cylinder head 114 and can be selectively opened and closed by an exhaust valve 136. If the exhaust valve 136 is opened when the piston 110 moves from the BDC position to the TDC position in the cylinder 108, the exhaust gasses therein will be pushed through the exhaust port 134 and into the exhaust manifold 130. To return the exhaust gasses to the atmosphere, the exhaust manifold 130 can be in fluid communication with an associated exhaust line 138 disposed through the engine system 100.

Selective opening and closing of the intake and exhaust valves 126, 136 can be controlled by a rotating camshaft 140 that can be supported over the engine block 104 and that extends generally over the plurality of combustion chambers 106. Referring to FIG. 2, the camshaft 140 can include a plurality of eccentric lobes 142 along its length with each lobe out-of-phase with respect to an adjacent lobe. Protruding vertically from the engine block 104 can be a plurality of valve stems or pushrods 146, each of which is slidably disposed through the cylinder head 114 and connected to an associated intake or exhaust valve 126, 136. A valve bridge 144 extends between the camshaft 140 and a cam follower 148 disposed on the distal end of each of the valve pushrods 146. As the camshaft 140 rotates, the eccentric lobes 142 cause the valve bridge 144 to pivot which causes the intake valve 126 and/or exhaust valve 136 to alternately move up and down with respect to the intake port 124 and exhaust port 134. A single camshaft 140 may activate both the intake valve 126 and the exhaust valve 136 as illustrated in FIG. 1 or two dedicated camshafts arranged parallel to each other may be separately associated with the intake valves and exhaust valves respectively as illustrated in FIG. 2. Referring back to FIG. 1, rotation of the camshaft 140, and thus timing of the intake and exhaust valve openings and closings, can be controlled by a camshaft actuator 149.

In an embodiment, the engine system can be operated in accordance with a Miller thermodynamic cycle in which one or more of the intake valves 126 stays open for a period after the piston 110 moves away from the BDC position or closes prior to the piston reaching the BDC position. This results in a smaller volume of intake air present in the variable volume 116 than would be present had the intake valve 126 closed during the transition when the piston 110 was at the BDC position between intake and compression strokes. For example, if the intake valve 126 closes late, a portion of the intake air drawn into the variable volume is expelled back out of the still-opened intake port 124. One effect of the Miller cycle is that actual compression, if compression is considered as a pressure increase in the combustion chamber, occurs later during the compression stroke once the intake valve 126 actually closes. The compression stroke may therefore be considered as having been shortened by the Miller cycle. Possible benefits of the Miller cycle include improved fuel economy, emissions reduction, change in timing of spontaneous ignition, and efficiency improvements for a given engine load.

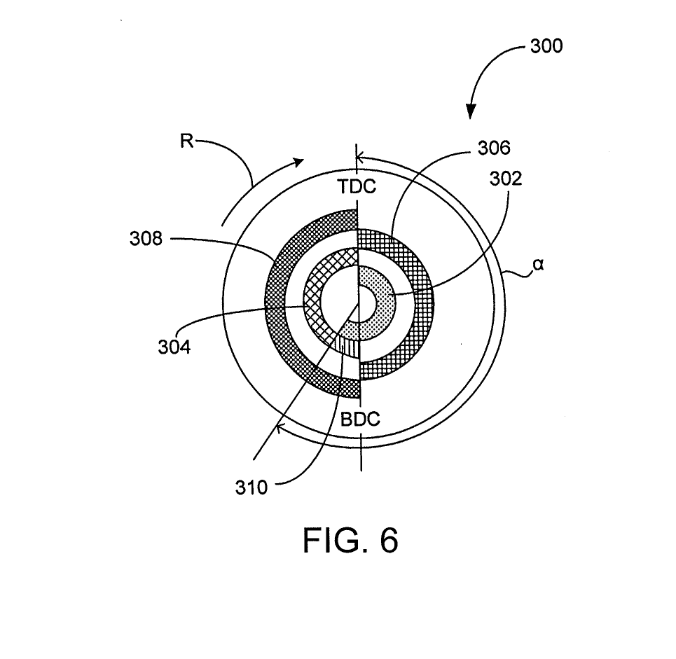

To enable a Miller cycle, the camshaft 140 and eccentric lobes 142 can be arranged to operate the intake and exhaust valves 126, 136 in accordance with the qualitative valve timing chart illustrated in FIG. 6. The chart 300 is a schematic representation of various valve opening and closing events with respect to linear translation of the piston and rotation of the crankshaft, which is representing as rotating in the clockwise direction indicated by arrow R. Accordingly, the TDC position of the piston or 0 degrees of rotation of the crankshaft is represented at the top of the chart 300 and the BDC position of the piston or 180 degrees of rotation of the crankshaft is represented by the bottom of the chart. The chart 300 represents the intake stroke 302, which happens in conjunction with an intake valve open condition, as occurring from the TDC position to approximately 0 to 45 degrees after the BDC position. The duration of the intake stroke 302 is indicated by angle a. The compression stroke 304, occurring in conjunction with the intake valve closed condition, occurs at the conclusion of the intake stroke 300 to approximately the TDC position. Thereafter, a power stroke 306 happening in conjunction with an exhaust valve closed condition can occur as the piston is forced from the TDC position to the BDC position and a subsequent exhaust stroke 308 happening in conjunction with the exhaust valve open condition can occur from the BDC position to the TDC position.

To prolong the intake stroke 302 and shorten the compression stroke 304, the intake valve can remain open for the additional portion of time after the piston leaves the BDC position indicated by the shaded area 310. During this time, a portion of the intake air is expelled from the cylinder delaying the start of compression until the intake valve closes. The duration of this time can be controlled as part of a process referred to as variable valve timing. Referring to FIG. 2, the arrangement of the eccentric lobes 142 along the camshaft 140, the speed of rotation of the camshaft, and/or the location of the camshaft relative to the valves can be selectively adjusted to alter the timing of the valve openings and closings. An example of variable valve timing is provided in U.S. patent application Ser. No. 12/952,033, which is incorporated by reference in its entirety. As is known, other methods exist for implementing variable valve timing such as additional actuators acting on the valve stems and the like.

Referring back to FIG. 1, to assist in directing the intake air to and exhaust gasses from the internal combustion engine 102, the engine system 100 can include a turbocharger 150. The turbocharger 150 includes a compressor 152 disposed in the intake line 128 that compresses intake air drawn from the atmosphere through an air filter 154 and directs the compressed air to the intake manifold 120. Although a single turbocharger 150 is shown, more than one such device connected in series and/or in parallel with another can be used. The air filter 154 can serve to filter particulates, moisture, and pollution from air drawn from the atmosphere. In some embodiments, to control or govern the amount of air drawn into the engine system 100, an adjustable governor or intake throttle 155 can be disposed in the intake line 128 between the air filter 154 and the compressor 152. The intake throttle 155 can be linked or controlled by an operator activated pedal 157 to adjust engine speed, though in other embodiments the pedal can control engine speed in a different manner. Because the intake air may become heated during compression, an intercooler 156 can be disposed in the intake line 128 between the compressor 152 and the intake manifold 120 to cool the compressed air. To power the compressor 152, a turbine 158 can be disposed in the exhaust line 138 and can receive pressurized exhaust gasses being expelled from the combustion chambers 106 through the exhaust manifold 130. The pressurized exhaust gasses directed through the turbine 158 can rotate a series of blades therein which are rotatably coupled to a series of blades in the compressor. One or more exhaust after-treatment devices 159 such as diesel particulate filters, catalytic convertors, mufflers, etc., may be disposed in the exhaust line 138 downstream of the turbine 158 to further treat the exhaust gasses before they are expelled to the atmosphere.

To reduce emissions and assist adjusted control over the combustion process, the engine system 100 can also include an exhaust gas recirculation (“EGR”) system that operates to draw exhaust gas from the engine's exhaust system and mix it with intake air. The EGR system forms an intake air/exhaust gas mixture that is introduced to the combustion chambers before or as the fuel is added. Two exemplary EGR systems are shown associated with the engine system 100 in FIG. 1, but it should be appreciated that these illustrations are exemplary and that either one, both, or neither can be used on the engine. It is contemplated that selection of an EGR system of a particular type may depend on the particular requirements of each engine application.

In the first embodiment, a high-pressure EGR system 160 operates to direct high-pressure exhaust gasses to the intake manifold 120 communicating with the intake runners 122. The high-pressure EGR system 160 includes a high-pressure EGR line 162 that communicates with the exhaust line 138 downstream of the exhaust manifold 130 and upstream of the turbine 158 to receive the high-pressure exhaust gasses being expelled from the combustion chambers 106. The system is thus referred to as a high-pressure EGR system 160 because the exhaust gasses received have yet to depressurize through the turbine 158. The high-pressure EGR line 162 is also in fluid communication with the intake manifold 120. To control the amount or quantity of the exhaust gasses combined with the intake air, the high-pressure EGR system 160 can include an adjustable EGR valve 164 disposed along the high-pressure EGR line 162. Hence, the ratio of exhaust gasses mixed with intake air can be varied during operation by adjustment of the adjustable EGR valve 164. Because the exhaust gasses may be at a sufficiently high temperature that may affect the combustion process, the high-pressure EGR system can also include an EGR cooler 166 disposed along the high-pressure EGR line 162 to cool the exhaust gasses.

In the second embodiment, a low-pressure EGR system 170 directs low-pressure exhaust gasses to the intake line 128 before it reaches the intake manifold 120. The low-pressure EGR system 170 includes a low-pressure EGR line 172 that communicates with the exhaust line 138 downstream of the turbine 158 so that it receives low-pressure exhaust gasses that have depressurized through the turbine. The system is thus referred to as a low-pressure EGR system because it operates using depressurized exhaust gasses. To control the quantity of exhaust gasses diverted, the low-pressure EGR line 172 may also include an adjustable EGR valve 174. The low-pressure EGR line 172 may communicate with the intake line 128 upstream of the intercooler 156 so that the exhaust gasses may be cooled before entering the combustion chambers 106.

To provide fuel of two different reactivities for the RCCI combustion process, the engine system 100 can be equipped with a first fuel system 180 configured to deliver a first fuel 182 of a first reactivity and a second fuel system 200 configured to deliver a second fuel 202 of a second reactivity. In an embodiment, the first fuel 182 can have a lower reactivity than the second fuel 202, for example, the first fuel can be gasoline and the second fuel can be diesel. Reactivity generally refers to the readiness of the fuel to combust upon compression ignition with higher reactivity fuels typically igniting more quickly than lower reactivity fuels. Reactivity can be related to the cetane number of the fuel that is a measure of the speed at which a fuel starts to auto-ignite under compression. Common diesel fuels may have a cetane number from about 40 to about 55 while common gasoline may have a research octane number of 90-100 RON, where the octane rating may be considered the opposite of cetane as the resistance to a fuel auto-igniting. The practical effect is that gasoline is typically less reactive than diesel. The rating numbers may vary though depending upon additives, conditioning, etc.

The first and second fuels 182, 202 can be stored and supplied to the internal combustion engine 102 separately. To store the first fuel 182, for example, gasoline, the first fuel system 180 can include a first fuel tank or reservoir 184 that may be periodically replenished. To direct the first fuel 182 to the internal combustion engine 102, the first fuel system 180 can include a first fuel line 186 that is in fluid communication with a plurality of electrically actuated first fuel injectors 188 that are associated with each combustion chamber 106. To pressurize the first fuel 182 and force it to flow through the first fuel line 186, a first fuel pump 190 can be disposed in the first fuel line between the first fuel reservoir 184 and the first fuel injectors 188. Also disposed in the first fuel line 186 can be a first filter or first conditioning module 192 for filtering or conditioning the first fuel 182. Similarly, the second fuel system 200 can include a second fuel reservoir 204 for storing the second fuel 202. The second fuel reservoir 204 can communicate with a plurality of second electrically actuated fuel injectors 208 that are associated with the combustion chambers 106 via a second fuel line 206 disposed through the engine system 100. The second fuel line 206 can also include a second fuel pump 210 for pressurizing the second fuel and a second fuel module 212 for filtering or conditioning the second fuel. In the illustrated embodiment, the first and second fuel injectors 188, 208 can be dedicated to separately introducing fuels of different reactivities. However, in other embodiments, a single, common fuel injector can be utilized to introduce fuels of different reactivities. Additionally, the first and second fuel injectors 188, 208 can directly access the combustion chamber 106 above or through the side of the cylinder to directly inject fuel or the can be associated with indirect injection features such as pre-injection chambers to indirectly introduce the fuel. In other embodiments, introduction methods other than a fuel injector, such as a carburetor or the like, can be utilized.

In addition to or instead of the two-fuel arrangement described herein, the engine system 100 can be configured to operate using a single fuel from a single fuel source whose reactivity is modified. Fuel reactivity can be modified by additives such as cetane enhancers or the like that can be mixed with a portion of the first fuel to create a second fuel of a second, higher reactivity. Additionally, the reactivity of the first fuel can be modified by catalytic convertors, permeable membrane separation, fuel reactors and the like.

To coordinate and control the various systems and components associated with the engine system 100, the system can include an electronic or computerized control unit, module or controller 220. The controller 220 is adapted to monitor various operation parameters and to responsively regulate various variables affecting engine operation. The controller 220 can include a microprocessor, an application specific integrated circuit (ASIC), or other appropriate circuitry and can have memory or other data storage capabilities. The controller can include functions, steps, routines, data tables, data maps, charts and the like saved in and executable from read only memory to control the engine system. Although in FIG. 1, the controller 220 is illustrated as a single, discrete unit, in other embodiments, the controller and its functions may be distributed among a plurality of distinct and separate components. To receive operating parameters and send control commands or instructions, the controller can be operatively associated with and can communicate with various sensors and controls on the engine system 100. Communication between the controller and the sensors can be established by sending and receiving digital or analog signals across electronic communication lines or communication busses. The various communication and command channels are indicated in dashed lines for illustration purposes.

For example, to monitor the pressure and/or temperature in combustion chambers 106, the controller 220 may communicate with chamber sensors 222 such as a transducer or the like, one of which may be associated with each cylinder 108 in the engine block 104. The chamber sensors 222 can monitor the combustion chamber conditions directly or indirectly. For example, by measuring the backpressure exerted against the intake or exhaust valves, or other components that directly or indirectly communicate with the combustion cylinder such as glow plugs, during combustion, the chamber sensors 222 and the controller 220 can indirectly measure the pressure in the cylinder 108. The controller can also communicate with an intake manifold sensor 224 disposed in the intake manifold 120 and that can sense or measure the conditions therein. To monitor the conditions such as pressure and/or temperature in the exhaust manifold 130, the controller 220 can similarly communicate with an exhaust manifold sensor 226 disposed in the exhaust manifold 130. From the temperature of the exhaust gasses in the exhaust manifold 130, the controller 220 may be able to infer the temperature at which combustion in the combustion chambers 106 is occurring. To measure the quality, quantity and/or temperature of the intake air, the controller 220 can also communicate with an intake air sensor 228 that may be associated with, as shown, the intake air filter 154 or another intake system component such as the intake manifold. The intake air sensor 228 may also determined or sense the barometric pressure or other environmental conditions in which the engine system is operating.

To determine the first reactivity of the first fuel 182, the controller 220 can communicate with a first reservoir sensor 230 disposed in or associated with the first fuel reservoir 184 and that can sense, for example, the cetane number of the first fuel. Likewise, the controller 220 can communicate with a second reservoir sensor 232 associated with the second fuel reservoir 204 to determine the second reactivity of the second fuel 202. Additionally, the controller 220 can determine the relative reactivity or difference between the first and second fuels 162, 182 by subtraction.

To further control the combustion process, the controller 220 can communicate with injector controls 240 that may be operatively associated with each of the first fuel injectors 188 and the second fuel injectors 208. The injector controls 240 can selectively activate or deactivate the first and second fuel injectors 188, 208 to determine the timing of introduction and the quantity of fuel introduced by each fuel injector. Additionally, the injector controls 240 can determine the relative or corresponding quantities of the first and second fuels 182, 202 and thus control the actual quantitative difference in reactivity in the combustion chambers 106. To further control the timing of the combustion operation, the controller 220 can also communicate with a camshaft control 242 that is operatively associated with the camshaft 140. By managing the speed and rotation of the camshaft 140, the controller 220 can control which valves are open and for how long, thereby controlling the quantity of intake air into and exhaust gasses out of the combustion chambers 106. Additionally, the camshaft control 242 can control the variable valve timing discussed above in connection with the Miller cycle. The camshaft control 242 can also determine the engine speed by, for example, measuring the rotational speed of the camshaft 140 that is representative of the speed of the crankshaft and translating pistons in the combustion chamber 106.

In those embodiments having an intake throttle 155, the controller 220 can communicate with a throttle control 244 associated with the throttle and that can control the amount of air drawn into the engine system 100. To measure activation of the pedal 157, the controller can also communicate with a pedal sensor 246. The controller 220 can also be operatively associated with either or both of the high-pressure EGR system 160 and the low-pressure EGR system 170. For example, the controller 220 is communicatively linked to a high-pressure EGR control 250 associated with the adjustable EGR valve 164 disposed in the high-pressure EGR line 162. Similarly, the controller 220 can also be communicatively linked to a low-pressure EGR control 252 associated with the adjustable EGR valve 174 in the low-pressure EGR line 172. The controller 220 can thereby adjust the amount of exhaust gasses and the ratio of intake air/exhaust gasses introduced to the combustion process by activating the throttle control, the high pressure EGR control 250 and/or low pressure EGR control 252.

The controller 250 can include programming or instructions for operating the engine system 100 under different operating conditions by selectively utilizing the two fuel sources equipped with the engine system. For example, under normal operating conditions when the engine is up to speed and at normal operating temperatures, the engine system 100 can combust both fuels 182, 202 during the combustion process but can switch to combusting primarily one fuel if operating speeds and temperatures are irregular, such as during start up or idling. The controller can thereby alter the combustion process depending upon the prevailing operating conditions. Under normal operating conditions, an exemplary series of event or stages for the engine to combust fuels having two different reactivities in, for example, an RCCI process are illustrated with respect to FIGS. 2-5. Starting with FIG. 2, during the intake stroke when the piston 110 moves from the TDC position toward the BDC position, the intake valve 126 is opened so that intake air can enter the expanding variable volume 116 through the intake port 124. Additionally, an initial fuel charge of a lower reactivity is introduced to the variable volume 116. This can be accomplished by injecting a plume 300 of the first fuel, e.g., gasoline, through the first fuel injector 168. This can occur during the intake stroke or just after the piston 110 reaches the BDC position so that the first plume 300 has time to homogenously mix with the intake air/exhaust gas mixture and disperse uniformly through the variable volume 116. In an alternative embodiment, the first fuel can be mixed with the intake air as the intake air enters the intake port.

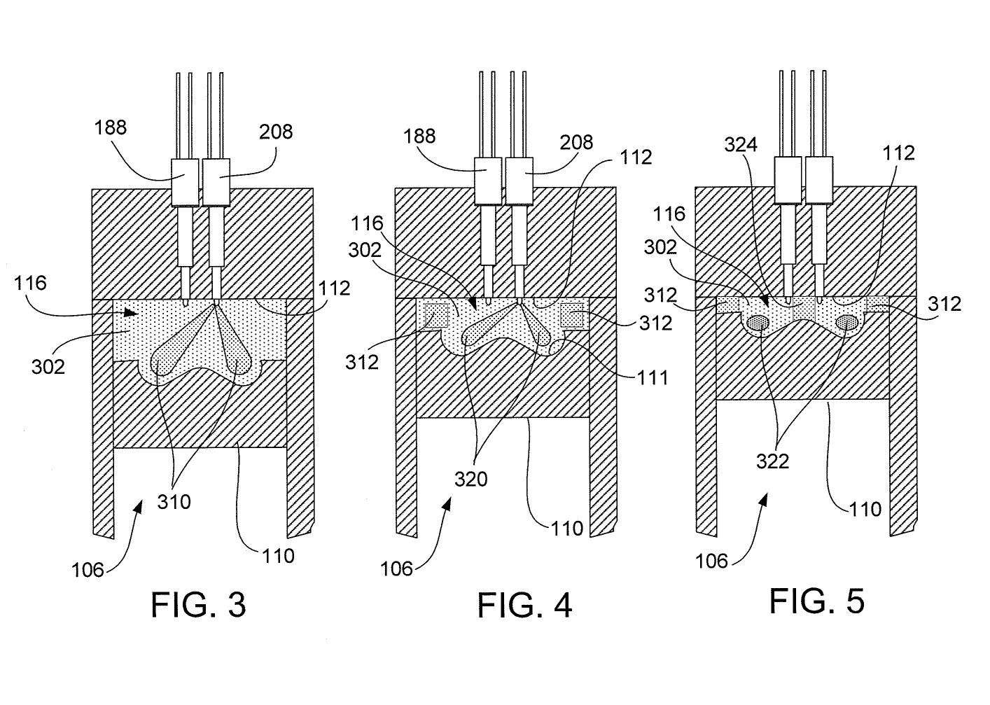

Referring to FIG. 3, an air/fuel mixture 302 formed from the intake air and the first fuel is compressed during the early compression stroke as the piston 110 begins to move from the BDC position toward the TDC position proximate the flame deck surface 112. During compression, the pressure and the temperature in the combustion chamber will begin to rise. At this time, the second fuel that may have a higher reactivity, e.g., diesel, can be introduced to the variable volume by injection through the second fuel injector 188. The second fuel plume 310 can be injected at any time between the BDC position of the piston 110 (180 degrees of crankshaft rotation before TDC) and 10 degrees before the TDC position (0 degree position). The controller can determine the timing of the second introduction during the compression stroke using the fuel injector controls.

Referring to FIG. 4, if the timing of the introduction of the second fuel plume occurs sufficiently early during the compression stroke, the second fuel may form first regions 312 of higher reactivity within the mixture 302 that may migrate or progress toward the outer periphery of the variable volume 116. If the piston 110 has a bowl 111 with an associated upward directed, outermost rim, the first regions 312 may become compressed or “squished” between the piston and the flame deck surface 112 at the outer periphery of the variable volume 116. At this stage, another introduction of higher reactivity fuel can be accomplished by injecting a third plume 320 into the variable volume 116. The third plume 320 can include the higher reactivity second fuel, such as diesel, or in other embodiments, it can be obtained from a different source having a different reactivity than either the first or second fuels. The third plume 320 might be relatively more centralized within the variable volume 116 and it might be generally directed toward the bowl 111 of the piston 110.

At the time the piston 110 reaches the TDC position, shown in FIG. 5, the higher reactivity fuel introduced by the third plumes may have formed second regions 322 located intermediately between the outer periphery and the center of the variable volume 116 and that may be proximately located within the bowl 111 of the piston 110. Additionally, there may be a third region 324 of higher reactivity fuel formed generally at the center of the variable volume 116 resulting from the diffuse fuel remaining proximate to the second fuel injector 188 after the third injection event. The first regions 312 may remain located at the outer periphery squished between the piston 110 and the flame deck surface 112 but, over time, may have diffused so that they have an intermediate reactivity compared to the mixture 302 and the second and third regions 322, 324.

Thus, at TDC just before combustion, the variable volume includes a plurality of regions of different reactivities that are stratified relative to each other. These regions include: (1) the mixture 302 of relatively low reactivity generally dispersed throughout the variable volume 116; (2) the first regions 312 of intermediate reactivity at the outer periphery; and (3) the second and third regions 322, 324 of higher reactivity that are generally centrally located. At the time the piston 110 reaches TDC, compression of the variable volume 116 and the associated pressure and temperature rise may reach a point where the contents of the variable volume spontaneously ignite. Combustion may initiate or begin in the second and third regions 322, 324 of higher reactivity and propagate to the first regions 312 of intermediate reactivity then through the mixture 302 dispersed through the variable volume 116. The difference in reactivity and the relative arrangement of the regions of different reactivity determines the time at which the regions of higher reactivity auto-ignite and/or the combustion rate or speed at which the flame propagates through the variable volume and thereby determines combustion efficiency, peak flame temperature and emissions.

However, irregular operating conditions of the engine may affect these results or outcomes, such as during cold start when the engine temperature is below normal or during idling when the engine is operating without any load so that its temperature and/or speed may fall. More particularly, the stratified regions may not form properly due to the irregular temperatures or engine speeds, and the spontaneous ignition of the regions may become unpredictable. This in turn can affect combustion rate, fuel efficiency, power output and emissions. Accordingly, the controller can switch to operate the engine using primarily a single fuel. Referring back to FIG. 1, to determine if the engine system 100 is operating under low temperature/speed (LTS) conditions such that single fuel combustion is appropriate, the controller 220 can measure or sense operating parameters such as cylinder pressure, engine coolant or oil temperature, exhaust temperature or engine speed using the chamber sensors 222, the exhaust manifold sensor 226 or the camshaft controller 242. Low values for these parameters may indicate that the engine 102 is starting up or is operating at idle. In a further embodiment, the controller 220 could, for example, measure the pedal sensor 246 to determine if the pedal 157 has been depressed and/or monitor other parameters to determine engine speed and loading to thus conclude the engine is operating at a low idle point. As can be appreciated by those of skill in the art, the low temperature/speed conditions could be sensed using other sensors in a more indirect manner. If the operating conditions of the engine system 100 rise to temperatures and speeds better-suited for combustion of fuels having different reactivities, i.e. a high temperature/speed (HTS) condition, the controller can switch to introducing the first and second fuels during the same combustion cycle to produce the stratified regions in the combustion chamber.

If the controller determines that a low temperature/speed condition is occurring, the controller 220 can select either the first fuel 182 having the first reactivity or the second fuel 202 having a second reactivity for combustion. For example, in an embodiment, the controller 220 can direct only the second fuel 202, which may be the higher reactivity diesel, to the combustion chamber 106 and turn off operation of the first fuel system 180. To exclude the first fuel 182 from the first fuel system 180, operation of the first fuel injectors 188 or of the first fuel pump 190 can be stopped. The second fuel 202 may be introduced to the combustion chamber 106 by the still active second fuel injectors 208 in one or more injections but, in the absence of the first fuel 182, could not form the stratified regions in the variable volume 116. The second fuel 202 could disperse uniformly through the combustion chamber 106 prior to ignition, which still may occur spontaneously upon the piston 110 moving to the TDC position during the compression stroke. The engine system would thus run as a diesel engine combusting strictly diesel fuel during each associated internal combustion cycle.

In another embodiment, the controller 220 could operate using primarily the lower reactivity first fuel 182, which may be gasoline, to the substantial exclusion of the higher reactivity second fuel 202. However, rather than completely shutting down the second fuel system 200 in such an embodiment, a small fraction of the second fuel 202 may continue to be introduced to the combustion chamber 106 as a pilot shot or pilot injection. This is because the lower reactivity first fuel 182 may not spontaneously ignite during the compression stroke in the complete absence of the higher reactivity second fuel 202. The volumetric ratio of the primary first fuel charge to the pilot charge may still be large, for example, 20:1. Such an embodiment would substantially operate as a gasoline engine combusting primarily gasoline.

Selection between operating the engine system on either the higher reactivity second fuel such as diesel or the lower reactivity first fuel such as gasoline can be based in part upon the particular criteria that the engine may be attempting to achieve, such as power output or emissions considerations. For example, combusting primarily higher reactivity diesel typically improves fuel efficiency with respect to gasoline-based engine systems. Additionally, diesel engines typically produce more power or torque at lower speeds, which may be advantageous if the engine is operating from a cold startup or from an idle state. The more reactive diesel may also more readily spontaneously ignite under unusually cold startup conditions and combustion of diesel may result in reduced carbon monoxide emissions. Conversely, combustion of primarily gasoline may reject more heat in the form of exhaust or heating of the engine parts so that engine operation temperature may rise more quickly to a point at which the two fuel-combustion process can be substituted. Additionally, combusting gasoline typically results in less soot production than diesel combustion and may produce less other emission such as nitrogen oxides.

A further difference between combustion of diesel and gasoline involves adjusting power output, which in a diesel engine is primarily a function of the fuel quantity introduced to the combustion chamber and in a gasoline engine is a function of the quantity of intake air introduced. Therefore, in diesel engines power adjustment is primarily controlled by the fuel injectors while in gasoline engines it is primarily controlled by the intake throttle.

### INDUSTRIAL APPLICABILITY

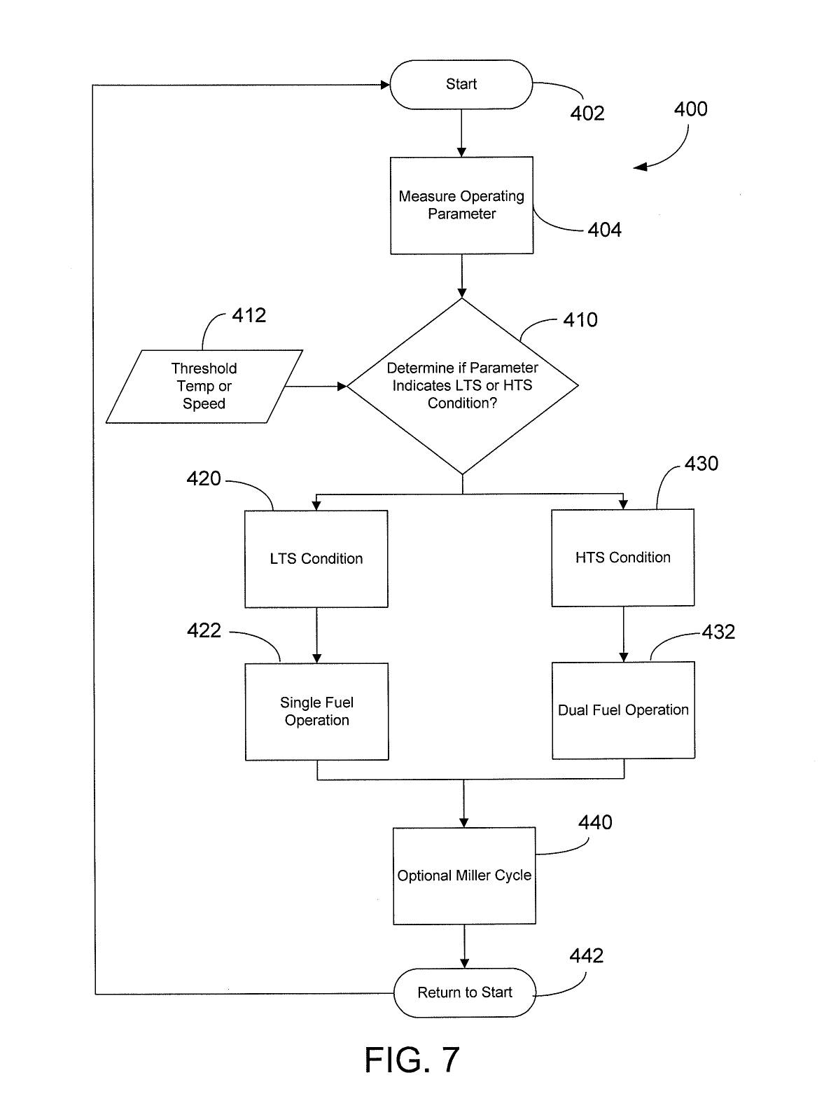

The present disclosure is applicable to internal combustion engines and, more particularly, to compression ignition engines switching between operation with a single fuel and two fuels of different reactivities. Referring to FIG. 7, there is illustrated a flowchart of an internal control process 400 that can be performed by an electronic controller and used with an engine system configured with two fuel sources having first and second fuels of different reactivities. After initiating in a start step 402, the process 400 in a measuring step 404 can measure an operating parameter of the internal combustion engine such as engine temperature, exhaust temperature or engine speed. As is known, engine temperature and engine speed and load are related in that generally the faster an engine runs and the larger the engine power is, more heat is rejected by the engine cylinders and thus a higher temperature exists within the engine cylinders during operation. These parameters are reflective of an operating state of the engine system, such as whether the engine system is starting from a cold startup condition or whether the engine is in a idle condition.

In a subsequent decision step 410, the control process 400 can assess the measured parameter to decide if a low temperature/speed (LTS) condition or a high temperature/speed (HTS) condition exists. For example, if the engine system is in a startup or idle condition, the low temperature of the air/fuel mixture in the engine cylinders before combustion may encumber the dual-reactivity mode of operation and the formation or combustion of stratified regions of different reactivity. Conversely, if cylinder temperatures are sufficiently high, indicating that the engine system is operating under normal conditions, loads and/or speeds, the dual-reactivity combustion process may be appropriate. To assist in performing the decision step 410, data 412 regarding a predetermined threshold temperature or speed can be input to the control process 400. The data 412 may be determined theoretically or empirically and may be stored in memory associated with the controller. The controller can also access data tables and maps reflecting known correlations between operating parameters and engine conditions and the controller can rely on those tables and maps to perform the decision step 412.

If it is determined in a determination step 420 that the engine system is in a LTS condition, the controller can conduct an first instruction step 422 to instruct the engine system to operate using primarily a single fuel. For example, the engine system may run on a higher reactivity second fuel such as diesel, included as part of the dual reactivity system, to provide the characteristics of a diesel combustion process. Alternatively, the engine system may be run primarily on a lower reactivity first fuel like gasoline using a pilot charge of diesel for spontaneous ignition to provide the characteristics of the gasoline combustion process. If instead it is determined in a determination step 430 that the engine system is in a HTS condition, the controller can issue instructions during an second instruction step 432 to operate the engine in a dual fuel mode using both the low reactivity first fuel and the high reactivity second fuel to produce and combust stratified regions of different reactivity.

The control process 400 may next determine whether to run an optional Miller cycle as described above in a Miller step 440. For example, if the engine system is operating in the single fuel mode, particularly using primarily gasoline, performing a Miller cycle may assist in throttling the engine system to lower or control the speed and reduce power by expelling a fraction of the intake air from the cylinder before combustion. The Miller cycle can also be run in the dual fuel mode to produce additional benefits. The process 400 can perform a return to start step 442 to repeat itself. By continuously performing the process 400, particularly the decision step 410, the process can switch between single fuel and dual fuel modes of operation as the operating conditions of the engine system change.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method of operating an internal combustion engine configured to utilize fuels of two different reactivities, the method comprising:
measuring an operating parameter of the internal combustion system;
introducing to a combustion chamber and combusting a first fuel having a first reactivity and a second fuel having a second reactivity during a high temperature/speed (HTS) condition of the internal combustion system, wherein introduction of the first fuel and second fuel occurs at different times during the internal combustion cycle; and
introducing to the combustion chamber and combusting primarily only one of the first fuel or second fuel during a low temperature/speed (LTS) condition of the internal combustion system.

2. The method of claim 1, wherein introduction of the first fuel occurs before introduction of the second fuel so that the first fuel disperses substantially homogeneously within the combustion chamber and the second fuel forms stratified regions in the combustion chamber.

3. The method of claim 2, wherein the first fuel is gasoline and the second fuel is diesel.

4. The method of claim 3, wherein the gasoline is introduced during the LTS condition and is ignited by introduction of a pilot charge of the diesel during a compression stroke.

5. The method of claim 3, wherein the diesel is introduced during the LTS condition and is ignited by a compression stroke.

6. The method of claim 1, wherein a piston moves in a cylinder of the combustion chamber through an internal combustion cycle including an intake stroke and a compression stroke wherein the piston moves from a top dead center (TDC) position to a bottom dead center (BDC) position and back, the internal combustion cycle further including a power stroke and an exhaust stroke wherein the piston again moves from the TDC position to the BDC position and back.

7. The method of claim 6, wherein the first fuel is introduced during an intake stroke and the second fuel is introduced during a compression stroke.

8. The method of claim 7, further comprising closing an intake valve associated with the combustion chamber during the compression stroke after the piston begins to move away from the BDC position toward the TDC position in accordance with a Miller thermodynamic cycle.

9. The method of claim 1, wherein the LTS condition corresponds to a startup condition or an idling condition of the internal combustion engine.

10. The method of claim 1, wherein the operating parameter is selected from the group consisting of engine temperature, exhaust temperature, and engine speed.

11. The method of claim 1, further comprising the steps of:
governing engine speed with an intake throttle during the LTS condition; and
governing engine speed with the first injector and second injector during the HTS condition.

12. An internal combustion engine system comprising:
a first fuel reservoir storing a first fuel of a first reactivity;
a second fuel reservoir storing a second fuel of a second reactivity;
an internal combustion engine including a combustion chamber having a piston movable in a cylinder in an internal combustion cycle;
a first injector associated with the combustion chamber for introducing the first fuel to the combustion chamber;
a second injector associated with the internal combustion chamber for introducing the second fuel to the combustion chamber;
a sensor measuring an operating parameter associated with the internal combustion engine;
a controller communicating with the sensor, the controller further controlling the first injector and second injector to introduce primarily only one of the first fuel or the second fuel during a low temperature/speed (LTS) condition of the internal combustion engine and to introduced both the first fuel and the second fuel during a high temperature/speed (HTS) condition of the internal combustion system, wherein introduction of the first fuel and second fuel occurs at different times during the internal combustion cycle.

13. The system of claim 12, wherein the first injector introduces the first fuel that the first fuel disperses substantially uniformly within the combustion chamber and the second injector introduces the second fuel so as to form stratified regions in the combustion chamber.

14. The system of claim 13, wherein the internal combustion cycle includes an intake-compression stroke where the piston moves from top dead center (TDC) position to a bottom dead center (BDC) position and back; and
wherein the first injector introduces the first fuel during an intake portion of the intake-compression stroke and the second injector introduces the second fuel during a compression portion of the intake-compression stroke.

15. The system of claim 14, further comprising an intake valve associated with the combustion chamber, the intake valve configured to open during the intake portion before the piston is at the BDC position and to close during the compression stroke after the piston leaves the BDC position.

16. The system of claim 12, wherein the LTS condition corresponds to a startup condition or an idling condition of the internal combustion engine.

17. The system of claim 12, wherein the first fuel is gasoline and the second fuel is diesel.

18. The system of claim 12, wherein the operating parameter is selected from the group consisting of engine temperature, exhaust temperature, and engine speed.

19. A method preformed by an electronic controller of operating an internal combustion engine system, the method comprising:
receiving a signal indicative of an operating parameter of the internal combustion engine system;
determining if the operating parameter indicates the internal combustion engine is in a low temperature/speed (LTS) condition or in a high temperature/speed (HTS) condition;
issuing a first instruction to operate the internal combustion engine system using primarily a first fuel having a first reactivity during the LTS condition;
issuing a second instruction to operate the internal combustion engine system using the first fuel having the first reactivity and a second fuel having a second reactivity during the HTS condition; and
repeating the method to switch between issuing the first instruction and issuing the second instruction depending upon change in the operating parameter.

20. The method of claim 19, further comprising receiving threshold data to compare with the operating parameter.
